(19) United States
(12) Patent Application Publication
(10) Pub. No.: US 2018/0257351 A1
(43) Pub. Date: Sep. 13, 2018

(54) OPTICAL FILM, IMAGE DISPLAY DEVICE, AND METHOD FOR MANUFACTURING OPTICAL FILM

(71) Applicant: FUJIFILM Corporation, Tokyo (JP)

(72) Inventors: Takayasu YAMAZAKI, Kanagawa (JP); Shuntaro IBUKI, Kanagawa (JP); Motoki ONISHI, Kanagawa (JP); Hiroyuki YONEYAMA, Kanagawa (JP)

(73) Assignee: FUJIFILM Corporation, Tokyo (JP)

(21) Appl. No.: 15/948,309

(22) Filed: Apr. 9, 2018

Related U.S. Application Data
(63) Continuation of application No. PCT/JP2016/082372, filed on Nov. 1, 2016.

(30) Foreign Application Priority Data
Nov. 16, 2015 (JP) 2015-224306
Mar. 25, 2016 (JP) 2016-061937

(51) Int. Cl. B32B 27/30; G02B 1/111; G02B 1/14; B05D 7/24; C08J 7/04; B32B 27/08; B32B 27/36

(52) U.S. Cl. CPC B32B 27/308; G02B 1/111; G02B 1/14; B32B 27/36; C08J 7/04; B32B 27/08; B05D 7/24

(57) ABSTRACT

An optical film includes a base material film including a (meth)acrylic resin and a first cured layer obtained by curing a first composition including a curable compound, in which the first cured layer is formed of a compatible layer and a first hardcoat layer, the compatible layer and the first hardcoat layer are provided in this order from the base material film side, and a pencil hardness of a surface of the optical film on the first cured layer side is H or more, and a peak intensity value of a power spectrum obtained by means of Fourier transformation of a reflectivity spectrum measured from the first cured layer side of the optical film by means of an optical interference-type non-contact surface shape measurement is 0.001 to 0.030. A method for manufacturing an optical film and an image display device includes the optical film.

### CROSS-REFERENCE TO RELATED APPLICATIONS

This application is a Continuation of PCT International Application No. PCT/JP2016/082372, filed on Nov. 1, 2016, which was published under PCT Article 21(2) in Japanese, and which claims priority under 35 U.S.C. § 119(a) to Japanese Patent Application No. 2015-224306, filed on Nov. 16, 2015, and Japanese Patent Application No.2016-061937, filed on Mar. 25, 2016. The above applications are hereby expressly incorporated by reference, in their entirety, into the present application.

### BACKGROUND OF THE INVENTION

### 1. Field of the Invention

The present invention relates to an optical film, an image display device, and a method for manufacturing an optical film.

### 2. Description of the Related Art

In the related art, as a protective member for an image display device such as a liquid crystal display (LCD), a plasma display (PDP), or an electroluminescent display (ELD), an optical film having a hardcoat layer formed on the surface of a triacetyl cellulose (TAC) base material has been used. However, recently, the use of an optical film including a transparent plastic base material containing a (meth)acrylic resin having a lower moisture permeability as a main component has been proposed (refer to JP2009-185282A and JP2013-222153A).

JP2009-185282A discloses a hardcoat film having a hardcoat layer on at least one surface of a transparent plastic film base material, in which the transparent plastic film base material includes at least one of an acrylic resin or a methacrylic resin, and the hardcoat layer is formed using a hardcoat layer-forming material including at least one of polyol acrylate or polyol methacrylate.

JP2013-222153A discloses a hardcoat film having a base material film containing a (meth)acrylic resin as a main component and a hardcoat layer, in which a compatible layer in which a material constituting the base material film and a material constituting the hardcoat layer are dissolved together is formed in the vicinity of an interface of the base material film on a hardcoat layer side.

### SUMMARY OF THE INVENTION

Optical films that are used as protective members for image display devices need to avoid the degradation of the visibility of images and have a high surface hardness.

In the hardcoat film disclosed by JP2009-185282A, a technique for improving hardness and adhesiveness with a specific solvent under specific drying conditions in a state in which the content of at least one of polyol acrylate or polyol methacrylate in the hardcoat layer-forming material is small (50% by mass or less) is disclosed, but the visibility of images is not confirmed. In addition, in the hardcoat film disclosed by JP2013-222153A, it is described that, due to the formation of the compatible layer, the base material film and the hardcoat layer have excellent adhesiveness, and it is possible to prevent the generation of an interference fringe between these layers, but a sufficiently high surface hardness cannot be obtained.

The present invention has been made in consideration of the above-described circumstances, and an object of the present invention is to provide an optical film which has a base material film containing a (meth)acrylic resin as a main component and a hardcoat layer, does not degrade the visibility of images in the case of being used as a protective member for an image display device, and has a high surface hardness. Another object of the present invention is to provide an image display device having an image display surface having a high visibility of images and a high surface hardness.

As a result of intensive studies for achieving the above-described objects, the present inventors found that an optical film which has a high surface hardness and does not easily allow the generation of interference unevenness can be obtained. The present invention has been completed on the basis of the above-described finding.

That is, the present invention provides [1] to [13] described below.

[1] An optical film comprising: a base material film including a (meth)acrylic resin; and a first cured layer obtained by curing a first composition including a curable compound, in which the first cured layer is formed of a compatible layer and a first hardcoat layer, the compatible layer and the first hardcoat layer are provided in this order from the base material film side, and a pencil hardness of a surface of the optical film on the first cured layer side is H or more, and a peak intensity value of a power spectrum obtained by means of Fourier transformation of a reflectivity spectrum measured from the first cured layer side of the optical film by means of an optical interference-type non-contact surface shape measurement is 0.001 to 0.030.

[2] The optical film according to [1], in which a film thickness of the first hardcoat layer is 2.0 μm to 7.0 μm, and a film thickness of the compatible layer is more than 1.0 μm to 10 μm or less.

[3] The optical film according to [1] or [2], in which the curable compound has a molecular weight of 400 or less and has three or more (meth)acryloyl groups in one molecule, and a content of the curable compound in the first composition is 70% by mass or more of a solid content mass of the first composition.

[4] The optical film according to any one of [1] to [3], further comprising: a second hardcoat layer, in which the base material film, the first hardcoat layer, and the second hardcoat layer are provided in this order.

[5] The optical film according to [4], in which the second hardcoat layer is a layer obtained by curing a second composition including a curable compound, and a content of a curable compound having a molecular weight of 400 or less and having three or more (meth)acryloyl groups in one molecule in the second composition is less than 70% by mass of a solid content mass of the second composition.

[6] The optical film according to [4] or [5], in which a film thickness of the first hardcoat layer is 5.0 μm or less, a film thickness of the second hardcoat layer is 5.0 μm or less, and a total of the film thicknesses of the first hardcoat layer and the second hardcoat layer is 3.0 μm to 10 μm.

[7] The optical film according to any one of [1] to [6], in which at least one of the first hardcoat layer or the second hardcoat layer includes an organic antistatic agent.

[8] The optical film according to [7], in which the organic antistatic agent has a quaternary ammonium salt.

[9] The optical film according to any one of [1] to [8], further comprising: a low-refractive-index layer.

[10] An image display device comprising: the optical film according to any one of [1] to [9].

[11] A method for manufacturing an optical film including a base material film including a (meth)acrylic resin and a first hardcoat layer comprising: applying a first composition including a curable compound and a solvent to at least one surface of the base material film; drying a coated film 1 obtained by the application; and forming the first hardcoat layer by curing the dried coated film 1, in which the curable compound has a molecular weight of 400 or less and has three or more (meth)acryloyl groups in one molecule, a content of the curable compound in the first composition is 70% by mass or more of a solid content mass of the first composition, and the drying is carried out at 70° C. to 120° C. for 100 seconds to 300 seconds.

[12] The method for manufacturing an optical film according to [11], in which the solvent has an SP value of 21 to 25 and a boiling point of 150° C. or lower.

[13] The method for manufacturing an optical film according to [11] or [12], further comprising: applying a second composition including a curable compound to the first hardcoat layer; drying a coated film 2 obtained by the application of the second composition; and forming a second hardcoat layer by curing the dried coated film 2, in which a surface curing percentage of the first hardcoat layer is 50% or less.

According to the present invention, an optical film which has a base material film containing a (meth)acrylic resin as a main component and a hardcoat layer, allows interference unevenness to a small extent, and has a high surface hardness is provided. It is possible to provide an image display device having an image display surface having a high visibility of images and a high surface hardness using the optical film of the present invention. The present invention also provides a method for manufacturing the optical film.

### DESCRIPTION OF THE PREFERRED EMBODIMENTS

Hereinafter, the present invention will be described. Meanwhile, constituent requirements will be described below on the basis of the typical embodiments or specific examples of the present invention, but the present invention is not limited to such embodiments or specific examples.

Meanwhile, in the present specification, numerical ranges expressed using “to” include numerical values before and after “to” as the lower limit value and the upper limit value.

In the present specification, “(meth)acrylate” represents “any one or both of acrylate and methacrylate”, “(meth)acryl” represents “any one or both of acryl and methacryl”, and “(meth)acryloyl” represents “any one or both of acryloyl and methacryloyl”.

1. Optical Film

An optical film of the present invention is a film that can be used in an image display device. The optical film of the present invention is preferably used as a protective member for an image display portion of an image display device. The optical film of the present invention is capable of functioning as, particularly, a hardcoat film on the outermost surface of an image display portion of an image display device. The optical film of the present invention includes a base material film including a (meth)acrylic resin and a first cured layer obtained by curing a first composition including a curable compound having a (meth)acryloyl group. Here, the base material film may be adjacent to the first cured layer and is preferably in direct contact with the first cured layer.

The optical film of the present invention allows interference unevenness to a small extent. Specifically, the peak intensity value of a power spectrum obtained by means of Fourier transformation of a reflectivity spectrum measured from the first cured layer side of the optical film by means of an optical interference-type non-contact surface shape measurement is 0.001 to 0.030. The reflectivity spectrum can be measured using a reflection spectroscopic film thickness meter. As the reflection spectroscopic film thickness meter, for example, FE-3000 (trade name) manufactured by Otsuka Electronics Co., Ltd. can be used.

The peak intensity value is more preferably 0.001 to 0.020. Due to the above-described property, the optical film of the present invention does not degrade the visibility of images in the case of being used as a protective member for an image display device.

In addition, in the optical film of the present invention, the pencil hardness of the surface of the optical film on the first cured layer side (the surface of the optical film which is located on the first cured layer side of the base material film as a criterion) is H or more. The pencil hardness is preferably 2H or more. In the present specification, the pencil hardness refers to a value obtained by evaluating a layer surface on the basis of JISK5400 (pencil scratch testing method).

In the present invention, the detail of a mechanism of obtaining an optical film having excellent optical characteristics while maintaining a sufficient surface hardness is not clear, but is assumed as described below. That is, in order to suppress interference unevenness in an optical film having a cured layer on a base material film, it is necessary to adjust the refractive index difference between the base material film and the cured layer. The present inventors confirmed that the formation of the first cured layer using the first composition described below generates an interface (compatible layer) that can be observed using a scanning electron microscope in the first cured layer. This compatible layer is assumed to be formed by the mutual dissolution (mixing) of a component forming the base material film and a component forming the hardcoat layer. In addition, it is considered to be because, as a result of using the first composition, a sufficient surface hardness can be ensured, and the compatible layer is also formed so as to be capable of sufficiently functioning as an adjustment layer that adjusts the refractive index difference between the base material film and the cured layer.

As described above, the first cured layer is formed of the compatible layer and the first hardcoat layer in this order from the base material film side. That is, the optical film of the present invention includes the base material film, the compatible layer, and the first hardcoat layer in this order. The optical film of the present invention may include a second hardcoat layer, an antiglare layer, a low-refractive-index layer, and a high-refractive-index layer or an intermediate-refractive-index layer.

2. Base Material Film Including (Meth)acrylic Resin

The base material film including a (meth)acrylic resin includes the (meth)acrylic resin as a main component. In the present specification, being included as the main component means that the content is 50% by mass or more of the solid content mass. The content of the (meth)acrylic resin in the base material film is preferably 60% by mass or more and more preferably 70% by mass or more of the solid content mass of the base material film. Meanwhile, in the present specification, the solid content mass refers to a mass excluding a solvent.

In the present specification, the (meth)acrylic resin refers to (meth)acrylic acid or a polymer of a derivative of (meth)acrylic acid. The derivative is, for example, an ester. In addition, the “resin” refers to a polymer of two or more polymerizable compounds having the same or different structures and may be a homopolymer or a copolymer.

The (meth)acrylic resin is preferably an acrylic resin having a ring structure, and examples thereof include (meth)acrylic resins having a lactone ring structure or an imide ring structure.

Regarding the lactone ring-containing (meth)acrylic resin, it is possible to refer to Paragraphs 0021 to 0047 of JP2012-250535A or Paragraphs 0015 to 0093 of JP2012-8248A.

Regarding the (meth)acrylic resin having an imide ring structure, it is possible to refer to the description regarding (meth)acrylic resins having a glutarimide structure in Paragraphs 0021 to 0037 of JP2013-37057A.

As the base material film including the (meth)acrylic resin, a commercially available product may be used. Examples of the base material film including a commercially available (meth)acrylic resin include ACRYPLEN (manufactured by Mitsubishi Rayon Co., Ltd.), TECHNOLLOY (manufactured by Sumitomo Chemical Company, Limited), SUNDUREN (manufactured by Kaneka Corporation), and the like.

The film thickness of the base material film is preferably 10 μm to 150 μm and more preferably 20 μm to 100 μm. In a case in which the film thickness of the base material film is set to 10 μm or more, it is possible to uniformly produce the base material film. In addition, in a case in which the film thickness of the base material film is set to 150 μm or less, it is possible to reduce the thickness and weight of the optical film.

3. First Cured Layer

The first cured layer is a layer obtained by curing the first composition including a curable compound and is constituted of the compatible layer and the first hardcoat layer. In the present specification, a cured layer refers to a layer in which at least a part of a curable compound included in a composition for forming the cured layer is included in a form of a polymerized or polymerized and crosslinked compound.

The curable compound included in the first composition is preferably a curable compound having a molecular weight of 400 or less and having three or more (meth)acryloyl groups in one molecule. The first composition may include, in addition to the curable compound, other curable compounds, a polymerization initiator, an organic antistatic agent, and other additives.

(Curable Compound Having Molecular Weight of 400 or Less and Having Three or More (Meth)acryloyl Groups in One Molecule)

The curable compound having a molecular weight of 400 or less and having three or more (meth)acryloyl groups in one molecule is preferably a curable compound having a molecular weight of 300 to 400 and having three or four (meth)acryloyl groups in one molecule and more preferably a curable compound having a molecular weight of 300 to 380 and having three or four (meth)acryloyl groups in one molecule. Examples of the curable compound having (meth)acryloyl groups include pentaerythritol triacrylate and pentaerythritol tetraacrylate. The first composition may include one kind or two or more kinds of the curable compound having a molecular weight of 400 or less and having three or more (meth)acryloyl groups in one molecule.

The content of the curable compound having a molecular weight of 400 or less and having three or more (meth)acryloyl groups in one molecule in the first composition is preferably 70% by mass or more, more preferably more than 70% by mass, still more preferably 75% by mass or more, and particularly preferably 80% by mass or more of the solid content mass of the first composition. In a case in which the first composition includes a predetermined amount of the curable compound having (meth)acryloyl groups, it is possible to obtain optical films which have a higher surface hardness and do not easily allow the generation of interference unevenness.

(Other Curable Compounds)

The first composition may also include other curable compounds other than the curable compound having a molecular weight of 400 or less and having three or more (meth)acryloyl groups in one molecule.

Examples of the other curable compounds include compounds having a molecular weight of 400 or less and having two or less (meth)acryloyl groups in one molecule, compounds having a molecular weight of more than 400, and the like. As the other curable compounds, compounds having a molecular weight of more than 400 and having four or more (meth)acryloyl groups in one molecule are preferred.

The other curable compounds are not particularly limited, and examples thereof include (meth)acrylic acid diesters of a polyoxyalkylene glycol such as triethylene glycol di(meth)acrylate, dipropylene glycol di(meth)acrylate, polyethylene glycol di(meth)acrylate, and polypropylene glycol di(meth)acrylate; (meth)acrylic acid diesters of a polyhydric alcohol such as pentaerythritol di(meth)acrylate; EO-modified trimethylol propane tri(meth)acrylate, PO-modified trimethylol propane tri(meth)acrylate, EO-modified tri(meth)acrylate phosphate, trimethylol ethane tri(meth)acrylate, ditrimethylol propane tetra(meth)acrylate, dipentaerythritol tetra(meth)acrylate, dipentaerythritol penta(meth)acrylate, dipentaerythrotol hexa(meth)acrylate, pentaerythritol hexa(meth)acrylate, 1,2,3-chlorohexane tetramethacrylate, polyurethane polyacrylate, polyester polyacylate, caprolactone-modified tris(acryloxyethyl) isocyanurate, and the like.

The content of the other curable compounds in the first composition is preferably less than 30% by mass, more preferably 20% by mass or less, and still more preferably 15% by mass or less of the solid content mass of the first composition.

In a case in which the other curable compound is urethane (meth)acrylate, the content thereof is preferably less than 15% by mass and more preferably 10% by mass or less of the solid content mass of the first composition. This is because, in a case in which the content thereof is set to less than 15% by mass, a first cured layer in which the compatible layer is easily formed and which has a sufficient surface hardness is easily obtained.

In addition, in a case in which the first composition includes a polymer such as a (meth)acrylate polymer, the content thereof is preferably 5.0% by mass or less, more preferably 3.5% by mass or less, and still more preferably 2.0% by mass or less of the solid content mass of the first composition. This is because, in a case in which the content thereof is set to 5.0% by mass or less, the compatible layer is more easily formed.

(Polymerization Initiator)

The first composition may also include a polymerization initiator. In a case in which the first composition includes a polymerization initiator, it is possible to form a first cured layer having a sufficient surface hardness. As a result, it is possible to impart a sufficient surface hardness to optical films to be obtained. The polymerization initiator is not particularly limited as long as the polymerization initiator is capable of curing the curable compound in the first composition, and examples thereof include the photopolymerization initiator described in Paragraphs <0133>to <0151>of JP2009-098658A. The content of the polymerization initiator in the first composition is preferably 0.5% by mass to 8.0% by mass and more preferably 1.0% by mass to 5.0% by mass of the solid content mass of the first composition. In a case in which the content of the polymerization initiator is set to 0.5% by mass or more, it is possible to impart a sufficient surface hardness to optical films to be obtained. In addition, in a case in which the content of the polymerization initiator is set to 8.0% by mass or less, the number of crosslinking initiation points increases, and the crosslinking length between the curable compounds decreases, and thus it is possible to prevent the occurrence of a decrease in the hardness.

(Organic Antistatic Agent)

The first composition may also include an organic antistatic agent. In a case in which the first composition includes an organic antistatic agent, the first hardcoat layer includes the organic antistatic agent. In a case in which the first hardcoat layer includes the organic antistatic agent, it is possible to impart a favorable dust-wiping property to the first cured layer to be obtained, specifically, the surface of the first hardcoat layer. For example, the optical film may be provided with a peeling film in order to prevent contamination or scratches during transportation or the like, but there are cases in which, during the production of an image display device having the optical film, in a case in which the peeling film is peeled off from the optical film, display unevenness may be caused due to peeling charging. In a case in which the first composition includes the organic antistatic agent, it is possible to prevent the above-described display unevenness or the like caused in a case in which the peeling film is peeled off from the surface of the first hardcoat layer.

Meanwhile, the organic antistatic agent is preferably included in a layer which becomes the outermost surface for adhesion during use (during the adhesion to a polarizing film or the like), and thus the first hardcoat layer preferably includes the organic antistatic agent in a case in which the first hardcoat layer becomes the outermost surface.

The organic antistatic agent is not particularly limited, but is preferably an organic antistatic agent having a quaternary ammonium salt due to the low price and ease of handling. Examples of such an antistatic agent include ACRIT 1SX-3000 (manufactured by Taisei Fine Chemical Co., Ltd.) and the like. The content of the organic antistatic agent in the first composition is preferably 1% by mass or more and more preferably 2% by mass or more, and is preferably 15% by mass or less, more preferably 14% by mass or less, still more preferably 12% by mass or less, and particularly preferably 10% by mass or less of the solid content mass of the first composition. In a case in which the content of the organic antistatic agent is 1% by mass or more, it is possible to impart a sufficient antistatic property to the first cured layer to be obtained. In addition, in a case in which the content of the organic antistatic agent is set to 15% by mass or less, it is possible to prevent a decrease in the surface hardness of the hardcoat layer.

Meanwhile, in a case in which the first composition includes the organic antistatic agent having a quaternary ammonium salt, the content of the curable compound further having a polar group such as a hydroxyl group, a carboxyl group, or a urethane group in the curable compound having a molecular weight of 400 or less and having three or more (meth)acryloyl groups in one molecule is preferably 40% by mass or less of the total mass of the entire curable compound in the first composition. This is because, in a case in which the content of the curable compound having a polar group is set to 40% by mass or less, the degradation of the antistatic property is prevented by the interaction between the organic antistatic agent having a quaternary ammonium salt and the curable compound. In a case in which the organic antistatic agent having a quaternary ammonium salt and the curable compound having a molecular weight of 400 or less, having three or more (meth)acryloyl groups in one molecule, and further having a polar group are made to coexist in the above-described range in the hardcoat layer, it is possible to exhibit a more favorable antistatic property. One kind of the organic antistatic agent may be used singly or two or more kinds of the organic antistatic agents may be used in combination. An antistatic agent made of a compound having a polymerizable group in a molecule is more preferably used. This is because it is also possible to enhance the scratch resistance (film hardness) of the first cured layer.

(Other Additives)

In addition to the above-described components, the first composition may also include other additives as necessary. Examples of the other additives include an ultraviolet absorbent, a light stabilizer, a viscosity adjuster, an antioxidant, a refractive index adjuster, and the like.

As the refractive index adjuster, it is preferable not to use resin particles (the content thereof in the first composition is preferably set to 1% by mass or less, more preferably 0.5% by mass or less, and most preferably 0% by mass of the solid content mass of the first composition). This is because the generation of glare in an image display portion of an image display device is prevented.

In a case in which the optical film is used as a protective member for a high-definition image display device (specifically, having a definition of 110 ppi or more and more preferably 160 ppi or more), the arithmetic average roughness (Ra) of the optical film in the case of being measured at a cut-off length of 0.08 mm is preferably 0.02 or less and more preferably 0.01 or less. As described above, in a case in which the content of the resin particles in the first composition is 1% by mass or less of the solid content mass of the first composition, it is possible to suppress the generation of glare derived from the arithmetic average roughness of the optical film in an image display portion of an image display device including the optical film.

In a case in which the first hardcoat layer becomes the outermost layer, the first composition preferably includes a lubricant, an antifouling agent, a leveling agent, or the like.

In addition, the first composition may or may not include the maleimide group-containing resin described in JP2013-222153A. In a case in which the first composition includes the maleimide group-containing resin, the content of the maleimide group-containing resin in the first composition is preferably 20% by mass or less, more preferably 5.0% by mass or less, and still more preferably 1.0% by mass or less of the solid content mass of the first composition. A case in which the first composition does not include the maleimide group-containing resin means that the content of the maleimide group-containing resin in the first composition is 0% by mass of the solid content mass of the first composition.

(Solvent)

The first composition may also include a solvent. The solvent may be included in the first composition until the formation of the first cured layer and may not be substantially included in the first cured layer.

The solvent is preferably an organic solvent. The organic solvent preferably has a Hoy method-based SP value of 21 to 25 and a boiling point of 150° C. or lower and more preferably has a SP value of 22 to 24 and a boiling point of 120° C. or lower. The above-described organic solvent is easily dissolved in the base material including the (meth)acrylic resin, and thus the formation of the compatible layer becomes easy. In addition, it is possible to prevent the curing of a coated film of the first composition from being impaired by the solvent remaining in the coated film during the drying of the coated film of the first composition. The organic solvent is preferably methyl ethyl ketone or methyl acetate. A solvent obtained by mixing methyl ethyl ketone or methyl acetate and another solvent may also be used. Meanwhile, the SP value (solubility parameter) in the present invention is a value computed using the Hoy method, and the Hoy method is described in “POLYMER HANDBOOK FOURTH EDITION”.

4. First Hardcoat Layer and Compatible Layer

The film thickness of the first hardcoat layer is not particularly limited as long as the first hardcoat layer is capable of imparting a sufficient surface hardness to the optical film to be obtained, but is preferably 7.0 μm or less and more preferably 2.0 μm to 7.0 μm. In a case in which the film thickness of the first hardcoat layer is set to 2.0 μm or more, it is possible to impart a sufficient surface hardness to the optical film to be obtained. In addition, in a case in which the film thickness of the first hardcoat layer is set to 7 μm or less, it is possible to reduce the thickness of the optical film to be obtained and prevent the deterioration of the cutting property. In a case in which the optical film includes a second hardcoat layer described below, the film thickness of the first hardcoat layer is preferably 5.0 μm or less. Meanwhile, in the present specification, the film thicknesses of the first hardcoat layer and the compatible layer can be measured by carrying out a scanning electron microscopic analysis.

Meanwhile, the film thickness of the first cured layer is preferably 3.0 μm to 17 μm, more preferably 4.0 μm to 14 μm, and still more preferably 5.0 μm to 12 μm. In a case in which the film thickness of the first cured layer is set to 17 μm or less, it is possible to decrease the amount of the first composition applied and reduce the costs for producing the optical film.

The optical film of the present invention includes a compatible layer. The compatible layer is a part of a layer obtained by curing the first composition and is considered as a layer in which a part of the components of the first composition is mixed with the base material film and/or permeate the base material film and thus the components forming the base material film and the components forming the first hardcoat layer dissolve together (are present in a mixed form). In a case in which the optical film has the compatible layer between the first hardcoat layer and the base material film, it is possible to suppress the generation of interference unevenness to a small extent. The film thickness of the compatible layer is preferably 1.0 μm or more, more preferably more than 1.0 μm, still more preferably 1.1 μm or more, and particularly preferably 2.0 μm or more. The upper limit of the film thickness of the compatible layer is not particularly limited, but is preferably 10 μm or less, more preferably 7.0 μm or less, and still more preferably 5.0 μm or less.

The film thickness of the compatible layer that is formed in the first cured layer can be adjusted by adjusting the kind and content of the curable compound in the first composition, the solvent in the first composition, the drying conditions after the application of the composition to the base material film, and the like.

5. Second Hardcoat Layer

The optical film of the present invention may also include a second hardcoat layer. The second hardcoat layer can be provided as a layer that is provided on the surface of the first cured layer. That is, in a case in which the optical film of the present invention includes the second hardcoat layer, the base material film, the compatible layer, the first hardcoat layer, and the second hardcoat layer are laminated in this order. In a case in which the second hardcoat layer is provided, it is possible to improve functions such as the enhancement of the more favorable surface hardness.

The second hardcoat layer can be formed by curing a second composition including a curable compound.

The curable compound that is included in the second composition is preferably a polyfunctional monomer or polyfunctional oligomer having a photopolymerizable functional group.

Examples of the photopolymerizable functional group include unsaturated polymerizable functional groups such as a (meth)acryloyl group, a vinyl group, a styryl group, and an allyl group, and ring-opening polymerization-type polymerizable functional groups such as an epoxy-based compound. Among these, a (meth)acryloyl group is preferred.

Specific examples of the photopolymerizable polyfunctional monomer having the photopolymerizable functional group include (meth)acrylic acid diesters of an alkylene glycol such as neopentyl glycol acrylate, 1,6-hexanediol (meth)acrylate, and propylene glycol di(meth)acrylate; (meth)acrylic acid diesters of a polyoxyalkylene glycol such as triethylene glycol di(meth)acrylate, dipropylene glycol di(meth)acrylate, polyethylene glycol di(meth)acrylate, and polypropylene glycol di(meth)acrylate; (meth)acrylic acid diesters of a polyhydric alcohol such as pentaerythritol di(meth)acrylate; (meth)acrylic acid diesters of an ethylene oxide or propylene oxide adduct such as 2,2-bis{4-(acryloxy.diethoxy)phenyl} propane and 2,2-bis{4-(acryloxy.polypropoxy)phenyl} propane; and the like.

Furthermore, urethane (meth)acrylates, polyester (meth)acrylates, isocyanuric acid acrylates, and epoxy (meth)acrylates are also preferably used as the photopolymerizable polyfunctional monomer.

Among these, esters of a polyhydric alcohol and (meth)acrylic acid are preferred, and polyfunctional monomers having three or more (meth)acryloyl groups in one molecule are more preferred.

Specific examples thereof include (di)pentaerythritol tri(meth)acrylate, (di)pentaerythritol tetra(meth)acrylate, (di)pentaerythritol penta(meth)acrylate, (di)pentaerythritol hexa(meth)acrylate, tripentaerythritol triacrylate, tripentaerythritol hexatriacrylate, trimethylolpropane tri(meth)acrylate, trimethylol ethane tri(meth)acrylate, ditrimethylolpropane tetra(meth)acrylate, EO-modified trimethylolpropane tri(meth)acrylate, PO-modified trimethylolpropane tri(meth)acrylate, EO-modified phosphoric acid tri(meth)acrylate, 1,2,4-cyclohexane tetra(meth)acrylate, pentaglycerol triacrylate, 1,2,3-chlorohexane tetramethacrylate, polyester polyacrylate, caprolactone-modified tris(acryloxyethyl) isocyanurate, and the like.

Furthermore, examples thereof include resins having three or more (meth)acryloyl groups, for example, a polyester resin, a polyether resin, a (meth)acrylic resin, an epoxy resin, a urethane resin, an alkyd resin, a spiroacetal resin, a polybutadiene resin, a polythiol polyene resin, oligomers or prepolymers of a polyfunctional compound or the like such as a polyhydric alcohol, and the like which have a relatively low molecular weight.

Regarding specific compounds of polyfunctional acrylate-based compounds having three or more (meth)acryloyl groups, it is possible to refer to the description of <0096> and the like of JP2007-256844A.

Examples of urethane acrylates include urethane acrylate-based compounds obtained by reacting a hydroxyl group-containing compound such as an alcohol, polyol, and/or hydroxyl group-containing acrylate and an isocyanate or, as necessary, by esterifying a polyurethane compound obtained from the above-described reaction with (meth)acrylic acid.

Regarding the specific examples of specific compounds, it is possible to refer to the description of <0017> and the like of JP2007-256844A.

The second composition may further include an epoxy-based compound in order to alleviate contraction during curing. As monomers having an epoxy group, monomers having two or more epoxy groups in one molecule can be used, and examples thereof include the epoxy-based monomers described in JP2004-264563A, JP2004-264564A, JP2005-37737A, JP2005-37738A, JP2005-140862A, JP2005-140863A, JP2002-322430A, and the like. In addition, compounds having both an epoxy-based functional group and an acrylic functional group such as glycidyl (meth)acrylate are also preferably used.

The second composition may be identical to or different from the first composition. The second composition and the first composition may or may not include the same curable compound.

For example, the second composition, similar to the first composition, may or may not include the curable compound having a molecular weight of 400 or less and having three or more (meth)acryloyl groups in one molecule. In a case in which the second composition includes the curable compound having a molecular weight of 400 or less and having three or more (meth)acryloyl groups in one molecule, the content thereof may be 70% by mass or more, less than 70% by mass, 60% by mass or less, or 50% by mass or less of the solid content mass of the second composition.

The second composition may also include a polymerization initiator. Examples of the polymerization initiator included in the second composition include the polymerization initiators exemplified above as the polymerization initiator included in the first composition. The content of the polymerization initiator in the second composition may be in the same range as described as the content of the polymerization initiator in the first composition.

The second composition may include an organic antistatic agent, and thus the second hardcoat layer may include the organic antistatic agent. Examples of the organic antistatic agent included in the second composition include the organic antistatic agents exemplified above as the organic antistatic agent included in the first composition. The content of the organic antistatic agent in the second composition may be in the same range as described as the content of the organic antistatic agent in the first composition.

As described above, the organic antistatic agent is preferably included in the layer which becomes the outermost surface of the optical film from the viewpoint of developing a more favorable antistatic property. Therefore, in a case in which the second hardcoat layer becomes the outermost surface, the second composition preferably includes the organic antistatic agent. In a case in which the optical film of the present invention includes the second hardcoat layer, the first hardcoat layer preferably does not substantially include the organic antistatic agent (for example, the content of the organic antistatic agent in the first composition is less than 1.0% by mass).

The second composition may also include one or more of the other additives exemplified in the section of the first composition.

The second composition may include a solvent. Examples of the solvent included in the second composition include the solvents exemplified above as the solvent included in the first composition.

The film thickness of the second hardcoat layer is not particularly limited as long as the second hardcoat layer is capable of imparting a sufficient surface hardness to the optical film to be obtained, but is preferably 7.0 μm or less, more preferably 6.0 μm or less, and still more preferably 5.0 μm or less. The film thickness of the second hardcoat layer is preferably 3.0 μm or more. The total of the film thicknesses of the first hardcoat layer and the second hardcoat layer is preferably 3.0 μm to 10 μm and more preferably 4.0 μm to 7.0 μm since it is possible to impart a sufficient surface hardness to the optical film to be obtained, and both a favorable bending property and a low curling property are provided. The total of the film thicknesses of the first hardcoat layer and the second hardcoat layer can be obtained by subtracting the film thickness of the compatible layer that is obtained by a scanning electron microscopic analysis described below from the total of the film thicknesses of the first cured layer and the second hardcoat layer.

6. Antiglare Layer, Low-Refractive-Index Layer, High-Refractive-Index Layer, and Intermediate-Refractive-Index Layer

The optical film of the present invention may also include an antiglare layer, a low-refractive-index layer, and a high-refractive-index layer or an intermediate-refractive-index layer on the first hardcoat layer and/or the second hardcoat layer directly or through other layers.

The antiglare layer is more preferably a layer which includes a binder resin for the antiglare layer capable of imparting a hardcoat property and translucent particles for imparting an anti-glare characteristic and has a surface with an unevenness formed by protrusions of the translucent particles or protrusions formed of aggregates of a plurality of particles.

The low-refractive-index layer is a layer having a refractive index that is lower than the refractive index of a layer immediately below the low-refractive-index layer, and it is possible to use, for example, an inorganic substance-deposited layer, but the low-refractive-index layer is not limited thereto. Regarding the detail of the low-refractive-index layer, it is possible to refer to Paragraphs <0111> and <0112> of JP2011-136503A.

7. Method for Manufacturing Optical Film

The optical film of the present invention can be manufactured using a method including the application of the first composition to at least one surface of the base material film, the drying of a coated film 1 obtained by the application, and the formation of the first hardcoat layer by curing the dried coated film 1. At this time, the drying is preferably carried out at 70° C. to 120° C. for 100 seconds to 300 seconds.

The optical film of the present invention including the second hardcoat layer can be manufactured using a method including the application of the second composition to the surface of the first hardcoat layer obtained after the curing, drying a coated film 2 obtained by the application, and the formation of the second hardcoat layer by curing the dried coated film 2. The drying conditions at this time may be the same as described above.

The first composition and the second composition can be applied using, for example, a well-known application method of the related art such as a dip coating method, an air knife coating method, a curtain coating method, a roller coating method, a die coating method, or a gravure coating method, and, among these, a die coating method is preferred.

The coated film 1 obtained after the application of the first composition is preferably dried at 70° C. to 120° C. for 100 seconds to 300 seconds as described above, more preferably dried at 90° C. to 110° C. for 120 seconds to 240 seconds, and still more preferably dried at 95° C. to 105° C. for 120 seconds to 210 seconds. Under the above-described drying conditions, it is possible to form a compatible layer having a film thickness of 1 μm or more. A method for drying the first composition applied on the base material film is not particularly limited, and the first composition may be dried using a well-known method of the related art.

Similar to the coated film 1, the coated film 2 obtained after the application of the second composition is also preferably dried under the same condition. Under the above-described drying conditions, it is possible to form the second hardcoat layer having a sufficient hardness while preventing the solvent from remaining during the formation of the layer.

As a method for curing the coated film 1 or the coated film 2, a well-known method may be appropriately selected depending on the components in the first composition or the second composition, and the like respectively. Examples thereof include a method in which ultraviolet rays or electron beams are radiated, and a method in which ultraviolet rays are radiated is preferred.

The radiation energy of the ultraviolet radiation is preferably 10 mJ/cm² to 10 J/cm² and more preferably 25 to 1,000 mJ/cm². The illuminance is preferably 10 mW/cm² to 2,000 mW/cm², more preferably 20 mW/cm² to 1,500 mW/cm², and still more preferably 100 mW/cm² to 1,000 mW/cm². The light radiation may be carried out in an inert gas atmosphere such as nitrogen or under heating conditions in order to accelerate a photopolymerization reaction.

In the production of the optical film of the present invention including the second hardcoat layer, it is also preferable to form the coated film 2 after the first hardcoat layer is semi-cured so that the curing percentage of the surface of the first hardcoat layer reaches 50% or less and fully cure the coated film 1 during the curing of the coated film 2. The curing percentage can be determined by measuring the consumption ratio of polymerizable functional groups using an IR absorption spectrum. At this time, the radiation amount of the ultraviolet radiation to the coated film 1 is preferably 10 mJ/cm² to 100 mJ/cm².

8. Image Display Device

The optical film of the present invention can be used as, particularly, a protective member for a high-definition image display device such as a liquid crystal display (LCD) or an electroluminescent display (ELD). For example, the optical film of the present invention can be used as a protective film for a polarization element provided in an image display device, particularly, on at least one surface of a polarizing film.

The optical film of the present invention can be provided on the outermost surface of an image display portion (display) of an image display device so as to protect the image display portion. The optical film of the present invention is preferably provided on the first cured layer so that the surface on the base material film side faces the outermost surface of the image display portion (display). The optical film is preferably, for example, adhered thereto. It is possible to adhere at least one surface of a polarizer provided in the image display device and the surface on the base material film side.

### EXAMPLES

Hereinafter, the present invention will be more specifically described using examples. Materials, amounts used, ratios, processing contents, processing orders, and the like described in the following examples can be appropriately changed within the scope of the gist of the present invention. Therefore, the scope of the present invention is not limited to specific examples described below. Meanwhile, unless particularly otherwise described, “parts” and “%” are mass-based.

(Production of Composition for Forming Hardcoat Layer K1)

A composition for forming a hardcoat layer K1 described below was prepared.

| | |
|---|---|
| Curable compound A1 | 48.5 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

The details of the respective components in the composition K1 will be described below.

Curable compound A1: A mixture of pentaerythritol tetraacrylate and pentaerythritol triacrylate (manufactured by Nippon Kayaku Co., Ltd., trade name: KAYARAD PET30)

Initiator 1: 1-Hydroxy-cyclohexyl-phenyl-ketone (manufactured by BASF, trade name: IRGACURE 184)

Additive F: A fluorine-containing leveling agent (manufactured by DIC Corporation, trade name: MEGAFACE F-477)

Diluted solvent Y1: Methyl ethyl ketone

Diluted solvent Y2: Methyl acetate

Compositions for forming a hardcoat layer K2 to K11 were produced in the same manner except for the fact that the kind or amount of the curable compound used for the composition for forming a hardcoat layer K1 was changed.

(Composition for Forming Hardcoat Layer K2)

| | |
|---|---|
| Curable compound A2 | 48.5 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

The details of the respective components in the composition K2 will be described below.

Curable compound A2: Pentaerythritol tetraacrylate (manufactured by Shin Nakamura Chemical Co., Ltd., trade name: NK ESTER A-TMMT)

(Composition for Forming Hardcoat Layer K3)

| | |
|---|---|
| Curable compound A3 | 48.5 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

The details of the respective components in the composition K3 will be described below.

Curable compound A3: Trimethylolpropane triacrylate (manufactured by Osaka Organic Chemical Industry Ltd., trade name: VISCOAT295)

(Composition for Forming Hardcoat Layer K4)

| | |
|---|---|
| Curable compound A4 | 48.5 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

The details of the respective components in the composition K4 will be described below.

Curable compound A4: Ditrimethylolpropane tetraacrylate (manufactured by Shin Nakamura Chemical Co., Ltd., trade name: NK ESTER AD-TMP)

(Composition for Forming Hardcoat Layer K5)

| | |
|---|---|
| Curable compound A5 | 48.5 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

The details of the respective components in the composition K5 will be described below.

Curable compound A5: Trimethylolpropane EO 3.5 mole adduct triacrylate (manufactured by Osaka Organic Chemical Industry Ltd., trade name: VISCOAT360)

(Composition for Forming Hardcoat Layer K6)

| | |
|---|---|
| Curable compound A1 | 38.8 parts by mass |
| Curable compound A3 | 9.7 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

(Composition for Forming Hardcoat Layer K7)

| | |
|---|---|
| Curable compound A1 | 29.1 parts by mass |
| Curable compound A6 | 19.4 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

The details of the respective components in the composition K7 will be described below.

Curable compound A6: Polyethylene glycol-diacrylate (manufactured by NOF Corporation, trade name: BLEMMER ADE-200)

(Composition for Forming Hardcoat Layer K8)

| | |
|---|---|
| Curable compound A2 | 34.9 parts by mass |
| Curable compound A4 | 13.6 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

(Composition for Forming Hardcoat Layer K9)

| | |
|---|---|
| Curable compound A2 | 29.1 parts by mass |
| Curable compound A4 | 19.4 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

(Composition for Forming Hardcoat Layer K10)

| | |
|---|---|
| Curable compound A1 | 29.1 parts by mass |
| Compound M | 48.5 parts by mass |
| Initiator 1 | 1.5 parts by mass |
| Additive F | 0.04 parts by mass |
| Diluted solvent Y1 | 18.2 parts by mass |
| Diluted solvent Y2 | 10 parts by mass |

The details of the respective components in the composition K10 will be described below.

Compound M: Acryl polymer compound having a maleimide group in a side chain (manufactured by Toagosei Co., Ltd., trade name: ARONIX UVT-302)

(Composition for Forming Hardcoat Layer K11)

| | |
|---|---|
| Curable compound A2 | 39.8 parts by mass |
| Curable compound A4 | 8.7 parts by mass |
| Compound T | 7.1 parts by mass |
| Initiator 1 | 1.5 parts by mass |
| Additive F | 0.04 parts by mass |
| Diluted solvent Y1 | 40 parts by mass |
| Diluted solvent Y2 | 10 parts by mass |

The details of the respective components in the composition K11 will be described below.

Compound T: Quaternary ammonium salt-type antistatic polymer (manufactured by Taisei Fine Chemical Co., Ltd., trade name: ACRIT 1SX-3000, solid content concentration as an antistatic polymer: 35%)

### Example 1

(Production of Optical Film 1)

The composition for forming a hardcoat layer K1 was applied onto a base material film including a (meth)acrylic resin (film thickness: 30 μm, trade name: TECHNOLLOY S001G, manufactured by Sumika Acryl Co., Ltd.) using a gravure coater so that the amount applied reached 10.4 g/m². The obtained coated film was dried at 100° C. for 120 seconds and then cured by radiating ultraviolet rays at an illuminance of 400 mW/cm² and a radiation amount of 300 mJ/cm² using a 160 W/cm air-cooled metal halide lamp (manufactured by Eye Graphics Co., Ltd.) while carrying out nitrogen purging so as to create an atmosphere having an oxygen concentration of 1.0% by volume or less, thereby forming a first cured layer (a first hardcoat layer and a compatible layer) and obtaining an optical film 1.

(Measurement of Film Thicknesses of First Hardcoat Layer and Compatible Layer)

The obtained optical film 1 was cut using a microtome. After that, an etching treatment was carried out on the cross section, and the cross section was observed using a scanning electron microscope (manufactured by Hitachi Ltd., S4300) at an accelerated voltage of 10 kV and a magnification of 5,000 times. The interface location was specified from the obtained image, and the film thicknesses of the first hardcoat layer and the compatible layer were computed.

(Evaluation of Interference Unevenness)

After the surface of the optical film 1 on which the first hardcoat layer was not provided was scrubbed with abrasive paper and thus roughened, the surface was painted black using a magic pen, thereby producing a measurement specimen. The measurement specimen was set in a reflection spectroscopic film thickness meter (manufactured by Otsuka Electronics Co., Ltd., trade name: FE-3000), and a reflectivity spectrum was obtained using a D2 lamp light source. A Fourier analysis was carried out on the obtained reflectivity spectrum, and the peak intensity value of a power spectrum derived from interference unevenness was obtained. The measurement conditions and the computation conditions are as described below. A case of the peak intensity value of 0.030 or less was evaluated as G, and a case of the peak intensity value of more than 0.030 was evaluated as NG.

(Measurement Conditions)

Measurement method: Absolute reflectivity measurement mode: Manual

(Computation Conditions)

Material category: Standard

Algorithm: FFT

Computation method: Two layers two peaks

n1d1 form: FIX refractive index: Designate the refractive index of the hardcoat layer calculated using an Abbe refractometer

n2d2 form: FIX refractive index: Designate the average value of the refractive index of the base material and the refractive index of the hardcoat layer calculated using an Abbe refractometer

(Surface Hardness)

The pencil hardness evaluation described in JIS K-5400 was carried out. After the humidity of the optical film 1 was adjusted at a temperature of 25° C. and a humidity of 60% RH for two hours, the pencil hardness on the first cured layer side in a case in which the load was set to 4.9 N was obtained using the testing pencil specified by JIS S-6006. H or more was evaluated as G, and less than H was evaluated as NG.

(Light-Fast Adhesiveness)

On the optical film 1, 100-hour and 200-hour light-fast tests were carried out using SUPER XENON WEATHER METER SX75 (manufactured by Suga Test Instruments Co., Ltd.) in an environment of 60° C. and a relative humidity of 50%.

The humidity of the optical film 1 that had undergone the light-fast tests was adjusted under conditions of a temperature of 25° C. and a relative humidity of 60%, grid-shaped notches were provided on the surface on the first cured layer side, and a total of 100 lattice patterns were inscribed. Polyester pressure-sensitive adhesive tape No. 31B (manufactured by Nitto Denko Corporation) was attached to the lattice pattern-inscribed surface, the tape was pulled off from the attachment surface in the perpendicular direction after 30 minutes, and the number of the first cured layer pieces peeled off from the lattice patterns was counted. Each of the light-fast tests was carried out three times, the obtained average number of the pieces peeled off was computed, and the light-fast adhesiveness was rated from the testing time and the number of the pieces peeled off on the basis of the following four levels.

A: No peeled-off pieces were observed in the 200-hour light-fast test.

B: No peeled-off pieces were observed in the 100-hour light-fast test, but the number of the pieces peeled off in the 200-hour light-fast test was five or less.

C: No peeled-off pieces were observed in the 100-hour light-fast test, but the number of the pieces peeled off in the 200-hour light-fast test was more than five.

D: Peeled-off pieces were observed in the 100-hour light-fast test.

### Example 2

(Production of Optical Film 2)

An optical film 2 was produced in the same manner as in the production of the optical film 1 except for the fact that, in the production of the optical film 1, the composition for forming a hardcoat layer K2 was used instead of the composition for forming a hardcoat layer K1, and the characteristics were evaluated.

### Example 3

(Production of Optical Film 3)

An optical film 3 was produced in the same manner as in the production of the optical film 1 except for the fact that, in the production of the optical film 1, the composition for forming a hardcoat layer K6 was used instead of the composition for forming a hardcoat layer K1, and the characteristics were evaluated.

### Example 4

(Production of Optical Film 4)

An optical film 4 was produced in the same manner as in the production of the optical film 1 except for the fact that, in the production of the optical film 1, the composition for forming a hardcoat layer K8 was used instead of the composition for forming a hardcoat layer K1, and the characteristics were evaluated.

### Example 5

(Production of Optical Film 5)

An optical film 5 was produced in the same manner as in the production of the optical film 1 except for the fact that, in the production of the optical film 1, the composition for forming a hardcoat layer K11 was used instead of the composition for forming a hardcoat layer K1, and the characteristics were evaluated.

### Comparative Example 1

(Production of Optical Film 6)

An optical film 6 was produced in the same manner as in the production of the optical film 1 except for the fact that, in the production of the optical film 1, the composition for forming a hardcoat layer K3 was used instead of the composition for forming a hardcoat layer K1, and the characteristics were evaluated.

### Comparative Example 2

(Production of Optical Film 7)

An optical film 7 was produced in the same manner as in the production of the optical film 1 except for the fact that, in the production of the optical film 1, the composition for forming a hardcoat layer K4 was used instead of the composition for forming a hardcoat layer K1, and the characteristics were evaluated.

### Comparative Example 3

(Production of Optical Film 8)

An optical film 8 was produced in the same manner as in the production of the optical film 1 except for the fact that, in the production of the optical film 1, the composition for forming a hardcoat layer K5 was used instead of the composition for forming a hardcoat layer K1, and the characteristics were evaluated.

### Comparative Example 4

(Production of Optical Film 9)

An optical film 9 was produced in the same manner as in the production of the optical film 1 except for the fact that, in the production of the optical film 1, the composition for forming a hardcoat layer K7 was used instead of the composition for forming a hardcoat layer K1, and the characteristics were evaluated.

### Comparative Example 5

(Production of Optical Film 10)

An optical film 10 was produced in the same manner as in the production of the optical film 1 except for the fact that, in the production of the optical film 1, the composition for forming a hardcoat layer K9 was used instead of the composition for forming a hardcoat layer K1, and the characteristics were evaluated.

### Comparative Example 6

(Production of Optical Film 11)

An optical film 11 was produced in the same manner as in the production of the optical film 1 except for the fact that, in the production of the optical film 1, the composition for forming a hardcoat layer K10 was used instead of the composition for forming a hardcoat layer K1, and the characteristics were evaluated.

The evaluation results are shown in Table 1.

TABLE 1

| | | Film | | | | | |
|---|---|---|---|---|---|---|---|
| | | thickness | Film | | | | |
| | Composition | of | thickness | | | | |
| | for forming | hardcoat | of | | | | |
| | hardcoat | layer | compatible | Pencil | Interference | Light-fast | |
| | layer | (μm) | layer (μm) | hardness | unevenness | adhesiveness | Type |
| Optical film 1 | K1 | 5.1 | 4.5 | G | G | A | Example 1 |
| Optical film 2 | K2 | 6.6 | 2.1 | G | G | A | Example 2 |
| Optical film 3 | K6 | 6.8 | 3.5 | G | G | A | Example 3 |
| Optical film 4 | K8 | 6.6 | 1.4 | G | G | B | Example 4 |
| Optical film 5 | K11 | 6.4 | 1.6 | G | G | B | Example 5 |
| Optical film 6 | K3 | 3.2 | 7.1 | NG | G | A | Comparative |
| | | | | | | | Example 1 |
| Optical film 7 | K4 | 6.9 | 0.2 | G | NG | D | Comparative |
| | | | | | | | Example 2 |
| Optical film 8 | K5 | 6.5 | 0.7 | G | NG | D | Comparative |
| | | | | | | | Example 3 |
| Optical film 9 | K7 | 2.6 | 8 | NG | G | C | Comparative |
| | | | | | | | Example 4 |
| Optical film | K9 | 6.7 | 0.9 | G | NG | D | Comparative |
| 10 | | | | | | | Example 5 |
| Optical film | K10 | 7.1 | 0.7 | NG | G | D | Comparative |
| 11 | | | | | | | Example 6 |

Compositions for forming a hardcoat layer were produced according to formulations described below.

(Composition for Forming Hardcoat Layer K21)

| | |
|---|---|
| Curable compound A1 | 43.7 parts by mass |
| Initiator 1 | 1.4 parts by mass |
| Additive F | 0.04 parts by mass |
| Diluted solvent Y1 | 27.5 parts by mass |
| Diluted solvent Y2 | 27.5 parts by mass |

(Composition for Forming Hardcoat Layer K22)

| | |
|---|---|
| Curable compound A2 | 38.8 parts by mass |
| Initiator 1 | 1.2 parts by mass |
| Additive F | 0.04 parts by mass |
| Diluted solvent Y1 | 30 parts by mass |
| Diluted solvent Y2 | 30 parts by mass |

(Composition for Forming Hardcoat Layer K23)

| | |
|---|---|
| Curable compound A1 | 31.0 parts by mass |
| Curable compound A3 | 7.8 parts by mass |
| Initiator 1 | 1.2 parts by mass |
| Additive F | 0.04 parts by mass |
| Diluted solvent Y1 | 30.0 parts by mass |
| Diluted solvent Y2 | 30.0 parts by mass |

(Composition for Forming Hardcoat Layer K24)

| | |
|---|---|
| Curable compound A2 | 39.4 parts by mass |
| Curable compound A7 | 16.9 parts by mass |
| Initiator 1 | 1.7 parts by mass |
| Additive F | 0.04 parts by mass |
| Diluted solvent Y1 | 21.0 parts by mass |
| Diluted solvent Y2 | 21.0 parts by mass |

Curable compound A7: A mixture of dipentaerythritol hexaacrylate and dipentaerythritol pentaacrylate (manufactured by Nippon Kayaku Co., Ltd., trade name: KAYARAD DPHA)

(Composition for Forming Hardcoat Layer K25)

| | |
|---|---|
| Curable compound A2 | 40.0 parts by mass |
| Curable compound A4 | 13.8 parts by mass |
| Compound T | 8.3 parts by mass |
| Initiator 1 | 1.7 parts by mass |
| Additive F | 0.04 parts by mass |
| Diluted solvent Y1 | 15.6 parts by mass |
| Diluted solvent Y2 | 21.0 parts by mass |

### Example 7

(Production of Optical Film 101)

The composition for forming a hardcoat layer K21 was applied onto a base material film including a (meth)acrylic resin (film thickness: 30 μm, trade name: TECHNOLLOY S001G, manufactured by Sumika Acryl Co., Ltd.) using a gravure coater so that the amount applied reached 5.2 g/m². The obtained coated film was dried at 100° C. for 120 seconds and then semi-cured by radiating ultraviolet rays at an illuminance of 400 mW/cm² and a radiation amount of 30 mJ/cm² using a 160 W/cm air-cooled metal halide lamp (manufactured by Eye Graphics Co., Ltd.) while carrying out nitrogen purging so as to create an atmosphere having an oxygen concentration of 1.0% by volume or less, thereby forming a first hardcoat layer H-1 (in a semi-cured state) on a base material.

Next, the composition for forming a hardcoat layer K24 was applied onto the first hardcoat layer H-1 using the gravure coater so that the amount applied reached 5.2 g/m², dried at 100° C. for 120 seconds, and then fully cured by radiating ultraviolet rays at an illuminance of 400 mW/cm² and a radiation amount of 300 mJ/cm² using an air-cooled metal halide lamp while carrying out nitrogen purging so as to create an atmosphere having an oxygen concentration of 1.0% by volume or less, thereby producing an optical film 101. Meanwhile, the film thickness of the first hardcoat layer was 2.2 μm, and the film thickness of the second hardcoat layer was 3.8 μm.

### Example 8

(Production of Optical Film 102)

An optical film 102 was produced in the same manner as in the production of the optical film 101 except for the fact that, in the production of the optical film 101, the composition for forming a hardcoat layer K22 was used instead of the composition for forming a hardcoat layer K21, and the characteristics were evaluated. Meanwhile, the film thickness of the first hardcoat layer was 2.3 μm.

### Example 9

(Production of Optical Film 103)

An optical film 103 was produced in the same manner as in the production of the optical film 101 except for the fact that, in the production of the optical film 101, the composition for forming a hardcoat layer K23 was used instead of the composition for forming a hardcoat layer K21, and the composition for forming a hardcoat layer K25 was used instead of the composition for forming a hardcoat layer K24. Meanwhile, the film thickness of the first hardcoat layer was 2.9 μm, and the film thickness of the second hardcoat layer was 3.9 μm.

The evaluation results obtained by evaluating the pencil hardness, interference unevenness, and light-fast adhesiveness of the optical film 101 to the optical film 103 in the same manner as the evaluation of the optical films 1 to 11 are shown in Table 2.

In addition, in Table 2, the surface curing percentage after the formation of the first hardcoat layer was measured using a method described below. That is, the peak (1660 to 1800 cm⁻¹) area of a carbonyl group and the peak height (808 cm⁻¹) of a double bond were obtained from an IR measurement in a single-time reflection of the produced sample having the first hardcoat layer H-1 (in a semi-cured state) on the base material, and a value (hereinafter, represented by P101) was obtained by dividing the peak height of the double bond by the carbonyl group peak surface area. The same IR measurement was carried out on the same sample produced under conditions in which ultraviolet rays were not radiated, a value (represented by Q101) was obtained by dividing the peak height of the double bond by the carbonyl group peak surface area, and the surface curing percentage was calculated from these values using the following numerical expression.

Surface curing percentage=(1−(P101/Q101))×100 (%) Numerical Expression 1

Meanwhile, the numerical value of the hardcoat layer film thickness (μm) in the table represents the total of the film thicknesses of the first hardcoat layer and the second hardcoat layer. The total of the film thicknesses of the first hardcoat layer and the second hardcoat layer was obtained by subtracting the film thickness of the compatible layer which was obtained by a scanning electron microscopic analysis.

TABLE 2

| | Composition | Composition | Film | | Surface curing | | | | |
|---|---|---|---|---|---|---|---|---|---|
| | for forming | for forming | thickness | Film | percentage of | | | | |
| | first | second | of | thickness of | first hardcoat | | | | |
| | hardcoat | hardcoat | hardcoat | compatible | layer (in semi- | Pencil | Interference | Light-fast | |
| | layer | layer | layer (μm) | layer (μm) | cured state) | hardness | unevenness | adhesiveness | Type |
| Optical film | K21 | K24 | 6.0 | 2.7 | 41% | G | G | A | Example 8 |
| 101 | | | | | | | | | |
| Optical film | K22 | K24 | 6.1 | 2.1 | 47% | G | G | A | Example 9 |
| 102 | | | | | | | | | |
| Optical film | K23 | K25 | 6.8 | 2.1 | 45% | G | G | A | Example |
| 103 | | | | | | | | | 10 |

(Preparation of Hollow Silica Particle Dispersion Liquid (F))

Acryloyloxypropyl trimethoxysilane (20 parts) and diisopropoxy aluminum ethylacetate (1.5 parts) were added and mixed with a hollow silica particle fine particle sol (isopropyl alcohol silica sol, CS60-IPA manufactured by JGC C&C, the average particle diameter: 60 nm, the shell film thickness: 10 nm, the silica concentration: 20%, and the refractive index of the silica particles: 1.31) (500 parts), and then ion exchange water (9 parts) was added thereto. The components were reacted at 60° C. for eight hours and then cooled to room temperature, and acetyl acetone (1.8 parts) was added thereto, thereby obtaining a dispersion liquid (E). After that, solvent substitution using distillation under reduced pressure was carried out at a pressure of 4 kPa (30 Torr) while adding cyclohexanone thereto so that the content ratio of silica became almost constant, and, in the end, the concentration was adjusted, thereby obtaining a dispersion liquid (F) having a solid content concentration of 18.2%. The amount of isopropyl alcohol (IPA) remaining in the obtained dispersion liquid (F) was analyzed by means of gas chromatography and found out to be 0.5% or less.

(Preparation of Coating Fluid for Low-Refractive-Index Layer)

The respective components were mixed together and dissolved in methyl ethyl ketone as shown in Table 3, thereby producing a coating fluid for a low-refractive-index layer Ln1 having a solid content of 5%.

TABLE 3
Ln1: contents of individual components (solid content) (numerical values
are % by mass)

| | | | | | | | Hollow |
|---|---|---|---|---|---|---|---|
| | | | | Polymerization | | | silica particle |
| Binder | | | | initiator | | RMS-033 | dispersion liquid (F) |
| P-1 | 28 | DPHA | 10 | Irg.127 | 3 | 4 | 55 |

Meanwhile, abbreviations in the table are as described below.

“P-1”: The fluorine-containing copolymer P-3 described in JP2004-45462A (weight-average molecular weight: approximately 50,000)

RMS-033: Methacryloxy-modified silicone (manufactured by Gelest, Inc.)

### Example 12

(Production of Anti-Reflection Film 201)

A film A was produced in the same manner except for the fact that, in the production of the optical film 3, curing was carried out at the ultraviolet radiation amount set to 30 mJ/cm².

Ln1 was laminated and applied onto the surface of the first hardcoat layer in the film A, was cured by UV radiation of 600 mJ/cm² so as to form a low-refractive-index layer having a film thickness of 0.1 μm, thereby producing an optical film having an antireflection function. The evaluation results of the produced optical film were the same as those of the optical film 3 in terms of the pencil hardness, the interference unevenness, and the light-fast adhesiveness and were favorable.

What is claimed is:

1. An optical film comprising:
a base material film including a (meth)acrylic resin; and
a first cured layer obtained by curing a first composition including a curable compound,
wherein the first cured layer is formed of a compatible layer and a first hardcoat layer,
the compatible layer and the first hardcoat layer are provided in this order from the base material film side,
a pencil hardness of a surface of the optical film on the first cured layer side is or more, and
a peak intensity value of a power spectrum obtained by means of Fourier transformation of a reflectivity spectrum measured from the first cured layer side of the optical film by means of an optical interference-type non-contact surface shape measurement is 0.001 to 0.030.

2. The optical film according to claim 1,
wherein a film thickness of the first hardcoat layer is 2.0 μm to 7.0 μm, and a film thickness of the compatible layer is more than 1.0 μm to 10 μm or less.

3. The optical film according to claim 1,
wherein the curable compound has a molecular weight of 400 or less and has three or more (meth)acryloyl groups in one molecule, and
a content of the curable compound in the first composition is 70% by mass or more of a solid content mass of the first composition.

4. The optical film according to claim 1, further comprising:
a second hardcoat layer,
wherein the base material film, the first hardcoat layer, and the second hardcoat layer are provided in this order.

5. The optical film according to claim 4,
wherein the second hardcoat layer is a layer obtained by curing a second composition including a curable compound, and
a content of a curable compound having a molecular weight of 400 or less and having three or more (meth)acryloyl groups in one molecule in the second composition is less than 70% by mass of a solid content mass of the second composition.

6. The optical film according to claim 4,
wherein a film thickness of the first hardcoat layer is 5.0 μm or less,
a film thickness of the second hardcoat layer is 5.0 μm, or less, and
a total of the film thicknesses of the first hardcoat layer and the second hardcoat layer is 3.0 μm to 10 μm.

7. The optical film according to claim 1,
wherein the first hardcoat layer includes an organic antistatic agent.

8. The optical film according to claim 4,
wherein the second hardcoat layer includes an organic antistatic agent.

9. The optical film according to claim 7.
wherein the organic antistatic agent has a quaternary ammonium salt.

10. The optical film according to claim 8,
wherein the organic antistatic agent has a quaternary ammonium salt.

11. The optical film according to claim 1, further comprising:
a second hardcoat layer,
wherein the second hardcoat layer is a layer obtained by curing a second composition including a curable compound,
a film thickness of the first hardcoat layer is 2.0 μm to 5 μm, a film thickness of the second hardcoat layer is 5.0 μm or less, and a film thickness of the compatible layer is more than 1.0 μm to 10 μm or less,
the curable compound in the first composition has a molecular weight of 400 or less and has three or more (meth)acryloyl groups in one molecule,
a content of the curable compound in the first composition is 70% by mass or more of a solid content mass of the first composition,
the curable compound in the second composition is less than 70% by mass of a solid content mass of the second composition,
a total of the film thicknesses of the first hardcoat layer and the second hardcoat layer is 3.0 μm to 10 μm, and
at least one of the first hardcoat layer or the second hardcoat layer includes an organic antistatic agent.

12. The optical film according to claim 1, further comprising:
a low-refractive-index layer.

13. An image display device comprising:
the optical film according to claim 1.

14. A method for manufacturing an optical film including a base material film including a (meth)acrylic resin and a first hardcoat layer comprising:
applying a first composition including a curable compound and a solvent to at least one surface of the base material film;
drying a coated film 1 obtained by the application; and
forming the first hardcoat layer by curing the dried coated film 1,
wherein the curable compound has a molecular weight of 400 or less and has three or more (meth)acryloyl groups in one molecule,
a content of the curable compound in the first composition is 70% by mass or more of a solid content mass of the first composition, and
the drying is carried out at 70° C. to 120° C. for 100 seconds to 300 seconds.

15. The method for manufacturing an optical film according to claim 14,
wherein the solvent has an SP value of 21 to 25 and a boiling point of 150° C. or lower.

16. The method for manufacturing an optical film according to claim 14, further comprising:
applying a second composition including a curable compound to the first hardcoat layer;
drying a coated film 2 obtained by the application of the second composition; and
forming a second hardcoat layer by curing the dried coated film 2,
wherein a surface curing percentage of the first hardcoat layer is 50% or less.
